(19) United States
(12) Patent Application Publication
(10) Pub. No.: US 2003/0152069 A1
(43) Pub. Date: Aug. 14, 2003

(54) Bundling/de-bundling of low frequency digital data streams

(76) Inventors: Iris Schkilnik, Yahod (IL); Yakov Reshef, Hadera (IL)

Correspondence Address: LEFFERT JAY & POLGLAZE, P.A., P.O. BOX 581009, MINNEAPOLIS, MN, 55458-1009, US

(21) Appl. No.: 10/071,887

(22) Filed: Feb. 8, 2002

(51) Int. Cl. H04L 12/50

(52) U.S. Cl. 370/369

(57) ABSTRACT

A traffic concentrator for combining a plurality of digital data streams into at least one higher speed digital data stream is provided. The traffic concentrator includes a plurality of inputs that are adapted to receive the plurality of digital data streams. The traffic concentrator further includes a memory that has first and second portions. The traffic concentrator also includes a control circuit that is coupled to the plurality of inputs and the memory. The control circuit generates control signals for storing data from the plurality of digital data streams in one of the first and second portions of the memory during a first time slot. The control circuit further retrieves the data from the portion of the memory during a subsequent time slot for combination and transmission as the at least one higher speed digital data stream.

### TECHNICAL FIELD

The present invention relates generally to the field of telecommunications and, in particular, to bundling/de-bundling of low speed digital data streams.

### BACKGROUND

Telecommunications networks carry data between user equipment at diverse locations. Telecommunications networks include a wide variety of components to implement the various functions involved in transmitting data including, but not limited to, switches, copper cable, fiber optic links, transmitters, receivers, and the like.

Originally, telecommunications networks were designed to carry data in analog form over a transmission medium, e.g., copper wire. Over time, digital technology has been introduced into the telecommunications networks. For example, it is common practice to convert analog signals to a digital form using pulse code modulation (PCM). Conventional PCM signals include, for example, the so-called T1 (US) and E1 (Europe) digital formats. Conventionally, these digital formats transmit data with prescribed speed, e.g., T1 transmits signals at approximately 1.544 MHz.

In some circumstances, it is desirable to combine or bundle multiple low speed digital streams into one or more higher speed streams for transmission over a higher speed link. At the termination of the higher speed link, the low speed data streams are de-bundled from the higher speed data streams.

Bundling of the lower speed links is accomplished in circuits referred to as concentrators. A typical concentrator uses shift registers to combine or bundle the data coming in the low speed format to produce the high-speed outputs. Unfortunately, shift registers consume large portions of field programmable gate arrays used to implement the concentrators when implemented in this fashion. This unnecessarily increases the cost of the concentrator.

For the reasons stated above, and for other reasons stated below which will become apparent to those skilled in the art upon reading and understanding the present specification, there is a need in the art for a cost effective technique for bundling and de-bundling low speed digital data streams.

### SUMMARY

The above mentioned problems with bundling and de-bundling of low speed digital data streams and other problems are addressed by embodiments of the present invention and will be understood by reading and studying the following specification. Embodiments of the present invention use a memory circuit that stores one time slot of data from low speed digital data streams in a first portion during a first time slot and then reads out the data for transmission as high speed data during a subsequent time slot thereby using a memory circuit instead of shift registers to implement a concentrator. One advantage of using a memory circuit instead of shift registers is the substantial savings in size of a field programmable gate array (FPGA) used to implement the control circuitry for a concentrator.

More particularly, in one embodiment a traffic concentrator for combining a plurality of digital data streams into at least one higher speed digital data stream is provided. The traffic concentrator includes a plurality of inputs that are adapted to receive the plurality of digital data streams. The traffic concentrator further includes a memory that has first and second portions. The traffic concentrator also includes a control circuit that is coupled to the plurality of inputs and the memory. The control circuit generates control signals for storing data from the plurality of digital data streams in one of the first and second portions of the memory during a first time slot. The control circuit further retrieves the data from the portion of the memory during a subsequent time slot for combination and transmission as the at least one higher speed digital data stream.

### BRIEF DESCRIPTION OF THE DRAWINGS

FIG. 1 is a block diagram of an embodiment of a concentrator according to the teachings of the present invention.

FIG. 2 is a block diagram that illustrates concentration of pulse code modulation highways according to the teachings of the present invention.

FIG. 3 is a block diagram of one embodiment of a memory circuit for a concentrator according to the teachings of the present invention.

FIG. 4 is a block diagram of another embodiment of a memory circuit for a concentrator according to the teachings of the present invention.

FIG. 5 is a block diagram of an embodiment of a de-concentrator circuit according to the teachings of the present invention.

FIG. 6 is a block diagram of an embodiment of a memory circuit for a de-concentrator according to the teachings of the present invention.

FIG. 7 is a block diagram of another embodiment of a memory circuit for a de-concentrator according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

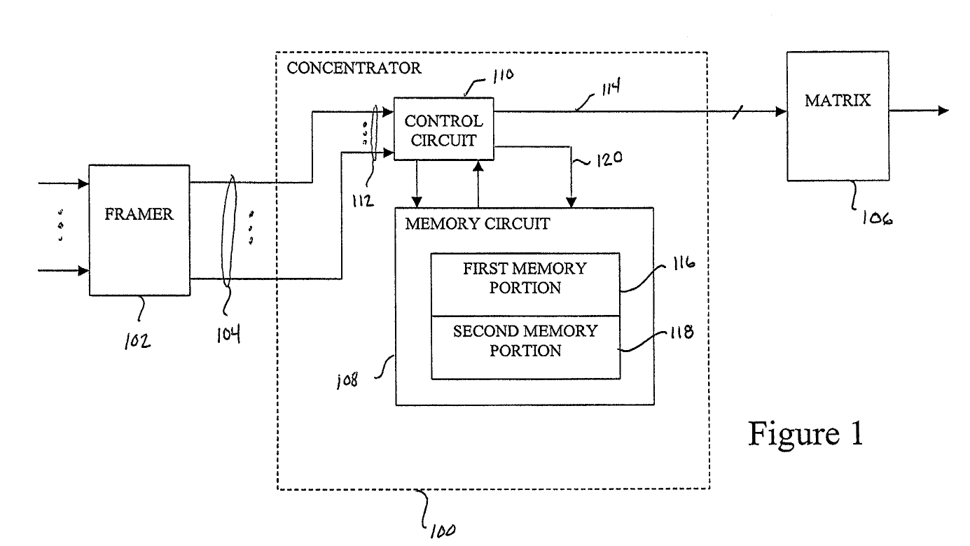

FIG. 1 is a block diagram of an embodiment of a concentrator, indicated generally at 100, according to the teachings of the present invention. Concentrator 100 receives a plurality of data streams at a first speed and combines the plurality of data streams into one or more data streams with a second, higher speed. Advantageously, concentrator 100 concentrates the low speed data streams using a memory circuit rather than a more conventional shift register approach.

Concentrator 100 receives the low speed digital data streams from framer 102 at inputs 104. In one embodiment, framer 102 produces a plurality of pulse code modulated (PCM) data streams or highways, e.g., T1, E1, or other appropriate standard PCM data streams. Concentrator 100 further provides the one or more high speed data streams to matrix 106 at output 114.

Concentrator 100 includes memory circuit 108 and control circuit 110. In one embodiment, memory circuit 108 comprises a dual port random access memory (RAM). Control circuit 110 is coupled to receive the low speed digital data streams from inputs 104 at inputs 112. Control circuit 110 is further coupled to memory circuit 108. Control circuit 110 provides data from the low speed data streams received at input 112 to memory circuit 108. Control circuit 110 further retrieves the data from memory circuit 108 and generates the high speed digital data streams to be applied to output 114 and matrix 106.

In one embodiment, control circuit 110 comprises a field programmable gate array (FPGA). Advantageously, the use of memory circuit 108 allows concentrator 100 to be implemented more economically by replacing conventional shift registers which typically consume large portions of the FPGA used to implement the concentrator.

Memory circuit 108 includes first memory portion 116 and second memory portion 118. Advantageously, concentrator 100 is able to operate without shift registers by storing data for one time slot of the low speed data streams in one of first and second memory portion 116, and 118 while reading data for another, earlier timeslot from the other of the first and second memory portion 116 and 118. Control circuit 110 also generates control signals that control the operation of memory circuit 108. These control signals are applied to memory circuit 108 at input 120.

In operation, concentrator 100 receives a plurality of low speed digital data streams from framer 102 and produces one or more higher speed digital data streams at output 114. Control circuit 110 generates control signals 120 to store data from the plurality of low speed digital streams for a first timeslot in the first memory portion 116. Subsequently, control circuit 110 generates control signals 120 to write data from the plurality of low speed digital streams for a second timeslot in the second memory portion 118. While data is written to second memory portion 118, the data from the first timeslot in the first memory portion 116 is readout under control of control circuit 110. Control circuit 110 further formats the data from first memory portion 116 to provide one or more higher speed digital data streams at output 114. As further timeslots are processed by concentrator 100, this process of reading from one memory portion while storing data in the other memory portion is repeated so as to concentrate the plurality of low speed digital streams at input 112 into one or more higher speed digital streams at output 114.

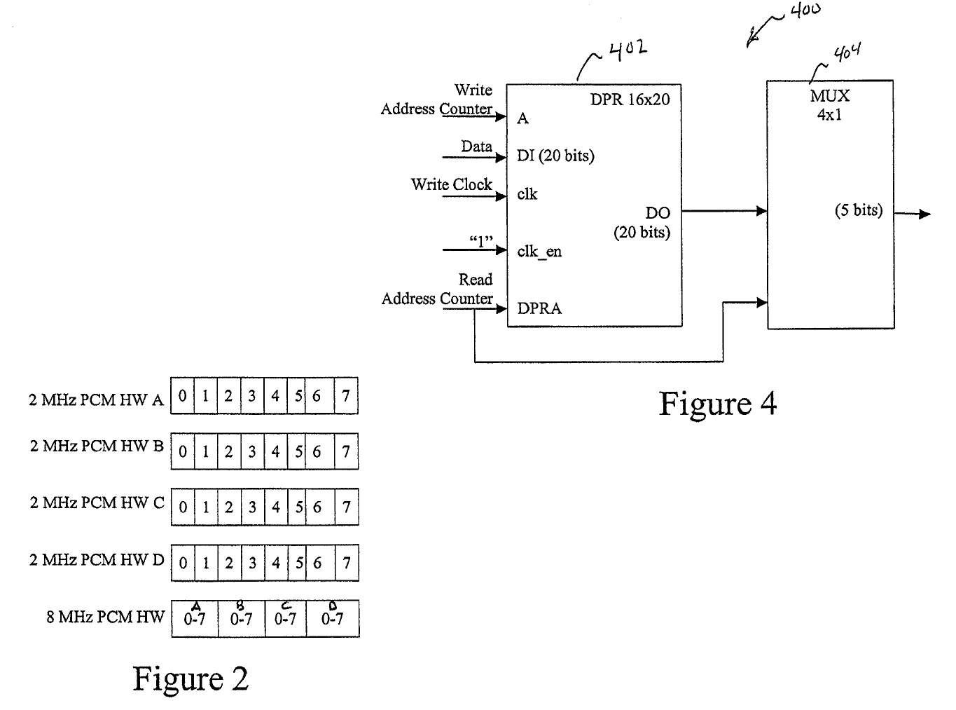

FIG. 2 is a block diagram that illustrates one example of signals processed by concentrator 100 of FIG. 1. In this example, framer 102 produces four, 2 MHz PCM highways identified as A, B, C and D. In FIG. 2, one time slot (eight bits) of data for each 2 MHz PCM Highway is shown. Further, the output of concentrator 100 comprises a single 8 MHz PCM Highway. The 8 MHz PCM Highway has a speed that is four times as fast as a 2 MHz PCM Highway. Thus, the 8 MHz PCM Highway is able to pass four times as much data in the same time as a single timeslot in a 2 MHz PCM Highway. Thus, in FIG. 2, the 8 MHz PCM Highway is illustrated as passing one timeslot (32 bits of data) with the data from one time slot (8 bits) of each of the four 2 MHz PCM highways A, B, C, and D.

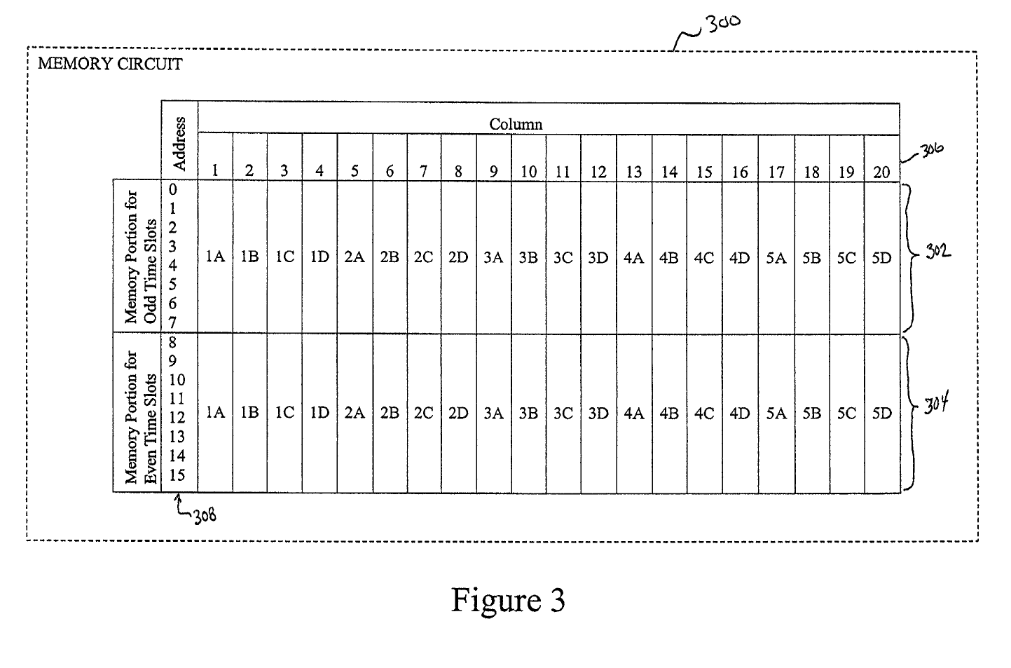

FIG. 3 is a block diagram of one embodiment of a memory circuit, indicated generally at 300, for a concentrator according to the teachings of the present invention. In this embodiment, the associated concentrator receives inputs from 20 different low speed digital data streams or PCM highways. Further, the associated concentrator produces five output data streams at a data rate that is four times higher that the data rate of the 20 low speed input data streams.

Memory circuit 300 comprises a dual port random access memory (RAM). This means that memory circuit 300 may read data from one address while simultaneously writing data to another address. Memory circuit 300 includes first and second memory portions 302 and 304, respectively. Memory portion 302 is adapted to store data for odd timeslots for 20 different low speed digital streams or PCM highways. Similarly, memory portion 304 is adapted to store data for even timeslots of the same low speed digital data streams or PCM highways.

Data is stored in the first and second memory portions 302 and 304 in an interleaved fashion. Each address indicated at 308 (addresses 0-15) of the memory circuit 300 corresponds to a row of data in memory circuit 300. Each bit of data in a row is received from a corresponding one of the 20 low speed data streams. Thus, each row includes one bit from each of the 20 data streams. The bits of a time slot for a selected digital data stream are thus stored in a single column spread out over 8 rows of memory circuit 300.

In this embodiment, memory circuit 300 is used to concentrate 20 low speed data streams into 5 high speed data streams. Each column in memory circuit 300 is labeled to indicate the high speed data stream to which it belongs. For example, column 9 is labeled 3A. The “3” indicates that this low speed data stream is concentrated into the output provided to the third output data stream. The “A” portion of the designation refers to the position of the low speed digital data stream within the structure of the high-speed digital data stream such as depicted in FIG. 2.

In an operation, memory circuit 300 receives data from 20 low speed digital data streams and provides the data as output for 5 higher speed digital data streams. Beginning with a first timeslot, data is stored in memory portion 302. This data includes digital data from 20 digital data streams of low speed data. For example the 20 digital data streams, in one embodiment, comprises 20 pulse code modulated digital data streams operating at approximately 2 MHz. In other embodiments, the 20 digital data streams comprise other appropriate digital data streams. The data is stored in memory portion 302 in such a manner that memory addresses 0-7 are each filled with 20 bit words. One bit in each word corresponds to a bit of the timeslot for the low speed digital data stream associated with the column of that bit.

During the next timeslot, data is stored in memory portion 304 while the data previously stored in memory portion 302 is read to form the concentrated, high speed data stream. In one embodiment, data in memory portion 302 is read four times during the time data is stored in memory portion 304. In the first pass, the columns labeled with an “A” are read, followed sequentially by the columns labeled “B”, “C” and “D”. During each of these passes, a five bit wide data stream is generated with each bit corresponding to one of the high speed data streams generated from the data stored in memory circuit 300. Since data is read at four times the speed the data is provided to memory circuit 300, each of the five output digital data streams receives data from one of each of the A, B, C, and D columns. In this manner, the 20 low speed data digital data streams are concentrated into five high-speed data digital data streams.

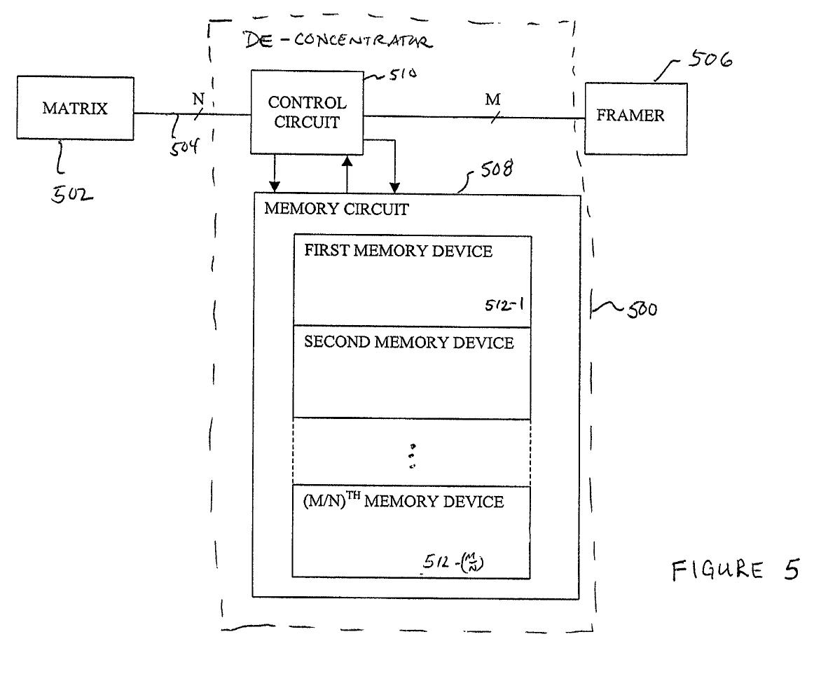

FIG. 4 is a block diagram of another embodiment of a memory circuit, indicated generally at 400, for a concentrator according to the teachings of the present invention. Memory circuit 400 includes memory device 402 and multiplexer 404. In this embodiment, memory device 402 comprises a dual port random access memory (RAM) with 20 columns and 16 rows. Further, in this embodiment, memory circuit 400 is used to concentrate 20 low speed digital data streams into five higher speed digital data streams.

Memory device 402 includes a plurality of inputs. First, memory device 402 receives a write address counter at input “A.” This counter counts through the addresses from 0 to 7 for writing odd timeslots and from 8 to 15 for writing even timeslots. In this manner, memory device 402 is effectively divided into two portions so the data is written to one portion of memory device 402 for one timeslot while data is read from another portion of memory device 402 for a prior timeslot.

Memory device 402 also receives 20 bits of inputs data at input DI. The speed of operation of memory device 402 is controlled by a clock signal received at input clk. In one embodiment, this write clock comprises a clock for a 2 MHz digital data stream. The operation of memory device 402 is enabled by a high logic signal applied to the input clk_en. Finally, memory device 402 receives a second counter used in reading data from memory device 402. This input is also applied to multiplexer 404.

Multiplexer 404 receives a 20 bit wide input (DO) from memory device 402. Multiplexer 404 selects five bits at a time of the 20 bit output from memory device 402 for application to five high-speed digital data streams at the output of multiplexer 404. Since the output data streams are four times faster than the input data streams, each output data stream carries data from four input data streams such as depicted in FIG. 2. Each bit in the output of multiplexer 404 corresponds to, for example, one 8 MHz PCM highway that carries four 2 MHz PCM highways.

FIG. 5 is a block diagram of one embodiment of a de-concentrator, indicated generally at 500, for de-bundling a plurality of digital data streams from one or more higher speed digital data streams. De-concentrator circuit 500 receives a plurality of digital data streams, N, from matrix 502 at input 504. De-concentrator circuit 500 further produces a plurality of output digital data streams, M, to framer 506. In one embodiment, de-concentrator 500 receives data from five 8 MHz PCM highways at input 504 and produces twenty 2 MHz PCM highways to framer 506. In other embodiments, other appropriate numbers of input and output digital data streams are provided. For example, in one embodiment, the ratio of the number of output data streams to the number of input data streams (MIN) is equal to the ratio of the speed of the output data streams divided by the speed of the input data streams. The relationship between the ratio of the number of data streams and the ratio of the speed of the data streams is selected to allow data from N high speed input digital data streams to be stored in the same time previously stored data from the N digital data streams is formatted for the M output digital data streams.

De-concentrator circuit 500 includes memory circuit 508 and control circuit 510. Control circuit 510 receives the plurality of input digital data streams from matrix 502 and provides the plurality of output digital data streams to framer 506. Control circuit 510 further provides control signals to control the storage of data from the digital data streams received at input 504 and retrieval of data from memory circuit 508 for transmission as the M output digital data streams. Control circuit 510 further is coupled to memory circuit 508 to store and retrieve data in a plurality of memory devices 512-1, . . . , 512-(M/N). In one embodiment, control circuit 510 is implemented in a field programmable gate array (FPGA). Advantageously, the design of de-concentrator 500 allows control circuit 510 to be implemented in a significantly smaller portion of a gate array compared to conventional circuits.

Each of memory devices 512-1, . . . , 512-(M/N) de-bundles a portion of the M output digital data streams from a portion of the data received on the N input digital data streams. Specifically, in this embodiment, each memory device 512-1, . . . , 512(M/N) de-bundles N of the M output digital data streams. In one embodiment, each memory device 512-1, . . . , 512-(M/N) is configured with two portions such that one portion receives one time slot of data from the N input data streams for a plurality of the lower speed data streams while the other portion provides data from a prior time slot to be formatted for transmission as lower speed data streams.

In operation, de-concentrator 500 receives a plurality of high-speed data streams at input 504 and produces a second plurality of lower speed digital data streams to framer 506. Control circuit 510 receives the plurality of high-speed data streams and, during a first timeslot, stores a portion of each high-speed data stream in a first portion of each of memory devices 512-1, . . . , 512-(M/N). For example, each memory device 512-1, . . . , 512-(M/N) stores one of the low speed digital data streams from each of the high-speed digital data streams received at input 504. During a subsequent timeslot, data is stored in a second portion of each of memory devices 512-1, . . . , 512-(M/N). During this same time slot, data is also read from the first portion of each of memory devices 512-1, . . . , 512-(M/N). The data read from the memory devices 512-1, . . . , 512-(M/N) is provided as the M output data streams to framer 506. Thus, memory devices 512-1, . . . , 512-(M/N) are used to de-bundle M lower speed digital data streams from N higher speed digital data streams.

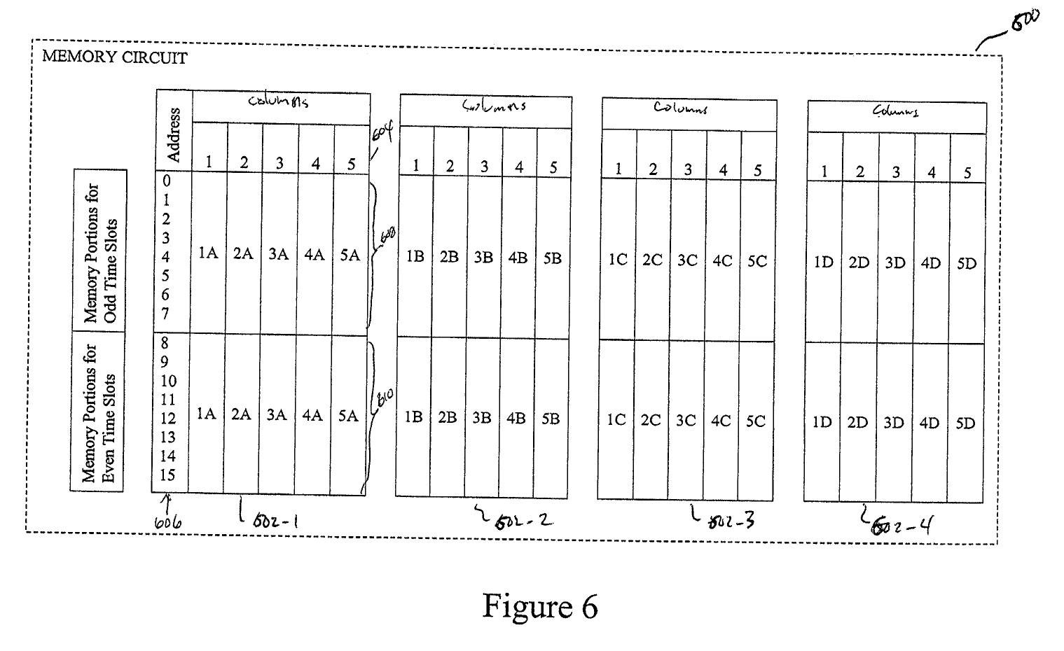

FIG. 6 is a block diagram of an embodiment of a memory circuit, indicated generally at 600, for a de-concentrator according to the teachings of the present invention. In this embodiment, memory circuit 600 includes four memory devices 602-1, . . . , 602-4. In one embodiment, memory devices 602-1, . . . , 602-4 are separate memory circuits. In other embodiments, memory devices 602-1, . . . , 602-4 are implemented in a single memory device. Further, memory circuit 600 is used in a system that de-bundles 20 2 MHz PCM highways from five 8 MHz PCM highways.

Each of memory devices 602-1, . . . , 602-4 are constructed in a similar manner, thus only memory device 602-1 is described in detail. Memory device 602-1 is a dual port memory. In one embodiment, memory device 602-1 is a dual port random access memory that allows two addresses to be written to/read from simultaneously. Thus, memory device 602-lis divided into two portions: namely, first portion 608 and second portion 610. First portion 608 stores data received on the 8 MHz PCM highway during a portion of the odd time slots. Specifically, since there are four memory devices, first portion 608 stores data during 1/4 of the 8 MHz PCM highway odd time slots. During the other ¾ of the odd time slots, data is stored in the other memory devices 602-2, . . . , 602-4. In this manner, data for one time slot for five 2 MHz PCM highways is stored in each of memory devices 602-1, . . . , 602-4 during a single (four times faster) timeslot of five 8 MHz PCM highways.

Data is stored in the memory devices 602-1, . . . , 602-4 in an interleaved fashion. This means that for each row address (0-7, 8-15) indicated at 606 in memory device 602-1, one bit for each of the five 2 MHz PCM highways is stored in memory device 602-1. Thus, rows 0-7 are used to store odd time slots for five “A” digital data streams in memory device 602-1 while rows 8-15 are used to store even time slots for five “A” digital data streams. Similarly, five “B”, five “C” and five “D” digital data streams are stored in memory devices 602-2, . . . , 602-4, respectively. Advantageously, while even time slots are written to the second memory portions of memory devices 602-1, . . . , 602-4, odd time slots are read out of the first memory portions of memory devices 602-1, . . . , 602-4. Since the input data streams are four times faster than the output data streams, data is written sequentially to memory devices 602-1, . . . , 602-4 one at a time and data is read from all four memory devices simultaneously.

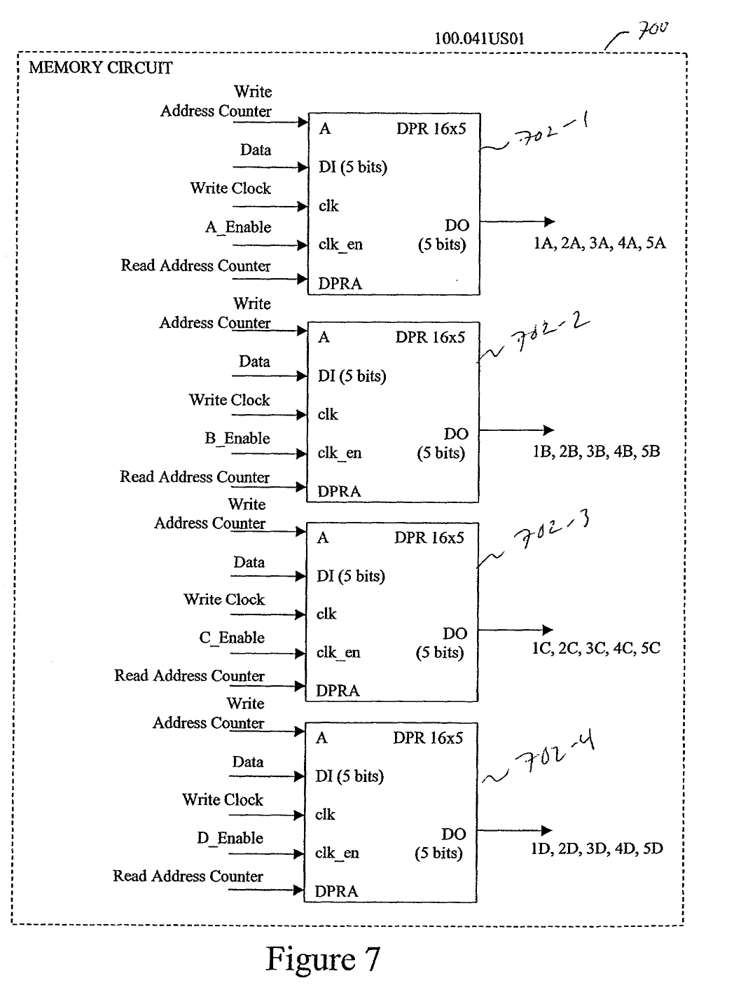

FIG. 7 is a block diagram of another embodiment of a memory circuit, indicated generally at 700, for a de-concentrator according to the teachings of the present invention. Memory circuit 700 includes a plurality of memory devices 702-1, . . ., 702-4. In this embodiment, each memory device 702-1, . . . , 702-4 is constructed in a similar manner. Thus, where possible, only memory device 702-1 is described. Memory device 702-1 comprises a dual port random access memory (RAM) with 5 columns and 16 rows. Further, in this embodiment, memory circuit 700 is used to de-concentrate or de-bundle 20 low speed digital data streams from five higher speed digital data streams.

Memory device 702-1 includes a plurality of inputs. First, memory device 702-1 receives a write address counter at input “A.” This counter counts through the addresses from 0 to 7 for writing odd timeslots and from 8 to 15 for writing even timeslots. In this manner, memory device 702-1 is effectively divided into two portions so the data is written to one portion of memory device 702-1 for one timeslot while data is read from another portion of memory device 702-1 for a prior timeslot.

Memory device 702-1 also receives 5 bits of input data at input DI. The speed of operation of memory device 702-1 is controlled by a clock signal received at input clk. In one embodiment, this write clock comprises a clock for an 8 MHz digital data stream. The operation of memory device 702-1 is enabled by a high logic signal applied to the input clk_en. This signal is high for ¼ of each 8 MHz time slot. Thus, each of memory devices 702-1, . . . , 702-4 store data during a selected ¼ of each 8 MHz timeslot. This is controlled by signals A_enable for memory device 702-1, B_enable for memory device 702-2, C_enable for memory device 702-3, and D_enable for memory device 702-4. Finally, memory device 702-1 receives a second counter used in reading data from memory device 702-1.

Each memory device 702-1, . . . , 702-4 provides five of the lower speed output digital data streams. Since the output digital data streams are 1/4 as fast as the input data streams, each memory device outputs five lower speed digital data streams simultaneously with the other of the memory devices.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. For example, the number of low speed digital data streams and the number of high speed digital data streams can be altered from the described embodiments to meet the needs of a specific application.

What is claimed is:

1. A traffic concentrator for combining a plurality of digital data streams into at least one higher speed digital data stream, the traffic concentrator comprising:
a plurality of inputs adapted to receive the plurality of digital data streams;
a memory having first and second portions;
a control circuit, coupled to the plurality of inputs and the memory, the control circuit generating control signals for storing data from the plurality of digital data streams in one of the first and second portions of the memory during a first time slot for retrieval from the portion of the memory during a subsequent time slot for combination and transmission as the at least one higher speed digital data stream.

2. The traffic concentrator of claim 1, wherein the memory comprises a dual port, random access memory.

3. The traffic concentrator of claim 2, wherein the memory comprises a number of columns equal to the number of the plurality of digital data streams and a number of rows equal to twice the number of bits per time slot.

4. The traffic concentrator of claim 1, wherein the plurality of inputs are adapted to receive at least one of T1 and E1 pulse code modulated (PCM) highways.

5. A method for bundling a plurality of digital data streams with a first speed to at least one digital data stream with a second, higher speed, the method comprising:
during even time slots in the plurality of digital data streams:
storing data from the plurality of digital data streams in a first memory portion, and
reading data from a second memory portion for transmission on the at least one digital data stream with a second, higher speed; and
during odd time slots:
storing data from the plurality of digital data streams in the second memory portion, and
reading data from the first memory portion for transmission over the at least one digital data stream with a second, higher speed.

6. The method of claim 5, wherein storing data from the plurality of digital data streams in a first memory portion comprises storing data from a plurality of pulse code modulated (PCM) highways.

7. The method of claim 5, wherein storing data from the plurality of digital data streams in a first memory portion comprises:
associating each column of the first memory portion with a selected one of the plurality of digital data streams;
storing the first bit of each of the plurality of digital data streams in a first row of the first memory portion, each bit stored in the column associated with its digital data stream; and
storing subsequent bits of each of the plurality of digital data streams in subsequent rows of the first memory portion, each bit stored in the column associated with its digital data stream.

8. The method of claim 5, wherein reading data from a second memory portion for transmission on the at least one digital data stream with a second, higher speed comprises reading the data from the second memory portion one time for each of the at least one digital data stream with a second, higher speed.

9. The method of claim 5, wherein reading data from a second memory portion for transmission on the at least one digital data stream with a second, higher speed comprises:
reading the data from the second memory portion one time for each of the at least one digital data stream with a second, higher speed; and
for each reading of the data from the memory, forming at least one digital data stream with a second, higher speed from a portion of the stored data from the plurality of digital data streams.

10. A de-concentrator for de-bundling a first plurality of digital data streams with a first speed into a second plurality of lower speed digital data streams, the de-concentrator comprising:
a plurality of inputs, each adapted to receive data over one of the first plurality of digital data streams;
a plurality of memory devices, each divided into a first portion and a second portion; and
a control circuit, coupled to the plurality of inputs and the plurality of memory devices, wherein data from a portion of a time slot of the first plurality of digital data streams is selectively stored in one of the first and second portions of each of the plurality of memory devices while data from another time slot of the first plurality of digital data streams is read from the other of the first and second portions of the plurality of memory devices to provide the second plurality of lower speed digital data streams.

11. The de-concentrator of claim 10, wherein the plurality of memory devices comprises a plurality of dual port memory devices.

12. The de-concentrator of claim 10, wherein the control circuit stores interleaved data for lower speed digital data streams in rows of the plurality of memory devices.

13. The de-concentrator of claim 10, wherein the control circuit stores data in one of the first and second portions of each of the plurality of memory devices during mutually exclusive portions of the time slot of the first plurality of digital data streams.

14. The de-concentrator of claim 10, wherein the first plurality of digital data streams comprises five 8 MHz pulse code modulation (PCM) highways and the second plurality of lower speed digital data streams comprises twenty 2 MHz PCM highways.

15. A method for de-bundling a first plurality of digital data streams from a second plurality of higher speed digital data streams, the method comprising:
receiving a first time slot of the second plurality of higher speed digital data streams;
sequentially storing selected portions of the first time slot of the second plurality of higher speed digital data streams in a first portion of a plurality of memory devices; and
simultaneously reading the data out of the first portion of each of the plurality of memory devices to provide the first plurality of digital data streams during a subsequent time slot of the second plurality of higher speed digital data streams.

16. The method of claim 15, wherein receiving a first time slot of the second plurality of higher digital data streams comprises receiving five 8 MHz digital data streams.

17. The method of claim 15, wherein sequentially storing selected portions comprises storing one-quarter of a time slot of data in each of the plurality of memory devices.

18. The method of claim 15, and further comprising sequentially enabling the plurality of memory devices to store data during a time slot of the second plurality of higher speed digital data streams.

19. A method for de-bundling a first plurality of digital data streams from a second plurality of higher speed digital data streams, the method comprising:
receiving a first time slot of the second plurality of higher speed digital data streams;
sequentially enabling a plurality of memory devices to store data during each time slot of the second plurality of higher speed digital data streams;
storing selected portions of the first time slot of the second plurality of higher speed digital data streams in a first portion of a plurality of memory devices when enabled; and
simultaneously reading the data out of the first portion of each of the plurality of memory devices to provide the first plurality of digital data streams while data is stored in a second portion of the plurality of memory devices during a subsequent time slot of the second plurality of higher speed digital data streams.

20. The method of claim 19, wherein receiving a first time slot of the second plurality of higher digital data streams comprises receiving five 8 MHz digital data streams.

21. The method of claim 19, wherein sequentially storing selected portions comprises storing one-quarter of a time slot of data in each of the plurality of memory devices.

22. A traffic concentrator for combining a plurality of pulse code modulated (PCM) highways into at least one higher speed PCM highway, the traffic concentrator comprising:
a plurality of inputs adapted to receive the plurality of PCM highways;
a dual port memory having first and second portions;
a control circuit, coupled to the plurality of inputs and the memory, the control circuit generating control signals for storing data from the plurality PCM highways in one of the first and second portions of the memory during a first time slot for retrieval from the portion of the memory during a subsequent time slot for combination and transmission as the at least one higher speed PCM highway.

23. The traffic concentrator of claim 22, wherein the memory comprises a number of columns equal to the number of the plurality of PCM highways and a number of rows equal to twice the number of bits per time slot.

24. The traffic concentrator of claim 22, wherein the plurality of inputs are adapted to receive at least one of T1 and E1 pulse code modulated (PCM) highways.
